(19) United States
(12) Patent Application Publication
(10) Pub. No.: US 2011/0238429 A1
(43) Pub. Date: Sep. 29, 2011

(54) TRACE INFORMATION ACQUISITION SYSTEM AND METHOD FOR ACQUIRING TRACE INFORMATION

(75) Inventors: Yoichiro KAWAKITA, Kyoto-shi (JP); Yasuaki NAKAJIMA, Kyoto-shi (JP); Shinji NAITO, Kyoto-shi (JP); Kenji YAMAMURA, Kyoto-shi (JP); Takayuki TOIGAWA, Kyoto-shi (JP)

(73) Assignee: OMRON CORPORATION, Kyoto-shi (JP)

(21) Appl. No.: 13/076,866

(22) Filed: Mar. 31, 2011

Related U.S. Application Data
(63) Continuation of application No. PCT/JP2009/067072, filed on Sep. 30, 2009.

(30) Foreign Application Priority Data
Oct. 9, 2008 (JP) 2008-263121
Oct. 9, 2008 (JP) 2008-263122
Oct. 9, 2008 (JP) 2008-263123

(51) Int. Cl. G06Q 10/00

(52) U.S. Cl. 705/1.1

(57) ABSTRACT

The trace information acquisition system acquires trace information about a product manufactured through a plurality of stages and includes storage unit that stores event data sets regarding events performed on the product and acquisition unit that acquires trace information from the event data sets stored by the storage unit. The event data set includes object data related to the event, personnel data related to the event, time data related to the event, positional data related to the event, and status data related to the event, and the event data sets stored at the plurality of stages have a common data format.

### CROSS-REFERENCE TO RELATED APPLICATION

This is a continuation application of PCT/JP2009/067072 filed Sep. 30, 2009, designating the United States of America, the disclosure of which, including the specification, drawings and claims, is incorporated by reference in its entirety. The disclosures of Japanese Patent Application Nos. 2008-263121 filed on Oct. 9, 2008; 2008-263122 filed on Oct. 9, 2008; and 2008-263123 filed on Oct. 9, 2008, including the specifications, drawings, and claims are expressly incorporated herein by reference in their entireties.

### FIELD OF THE DISCLOSURE

This disclosure relates to a trace information acquisition system and a method for acquiring trace information, and in particular to a system and method for acquiring trace information of a product manufactured through a plurality of stages.

### BACKGROUND INFORMATION

In view of product quality maintenance and improvement, the construction of a traceability system capable of tracing manufacturing processes of a product manufactured through a plurality of stages, or a system for acquiring trace information of a product, is in demand recently. Such a traceability technique for products is disclosed in, for example, Japanese Unexamined Patent Application Publication Nos. 2007-249326 and 2005-346280.

According to Japanese Unexamined Patent Application Publication No. 2007-249326, trace information covering a plurality of sequential processes is acquired by storing information for associating the respective processes and using the stored process-to-process association information. The traceability technique according to Japanese Patent Application Publication No. 2005-346280 is configured to store a pointer that indicates where product trace information is stored in a process chain including a series of processes and to use the stored pointer to acquire the product trace information.

### SUMMARY

The traceability used in Japanese Unexamined Patent Application Publication Nos. 2007-249326 and 2005-346280 requires storage of information about the process-to-process associations and the trace information pointer indicating where the trace information is stored. In other words, the absence of the process-to-process association information or equivalents results in failed acquisition of product trace information such as trace information about the quality of an in-process product in production processes and trace information about energy consumed in production processes of a product. Such process-to-process association information is sometimes not stored in fields not using a common infrastructure, for example, in different supply chains or in a range spreading across supply chains, and it is, therefore, impossible to acquire the trace information including the trace information about the quality of the in-process product in the production processes and trace information about energy in the production processes of the product. In short, trace information including the trace information about the quality of an in-process product in production processes and trace information about energy in production processes of a product cannot be acquired in the fields not sharing an infrastructure.

A non-limiting feature of the disclosure is to provide a trace information acquisition system capable of acquiring trace information, such as trace information regarding the quality of an in-process product in production processes and trace information regarding energy in production processes of a product, even in the fields not sharing an infrastructure.

It is another aspect of the present disclosure to provide a method for acquiring trace information, such as trace information regarding the quality of an in-process product in production processes and trace information regarding energy in production processes of a product, even in the fields not sharing an infrastructure.

It is yet another aspect of the present disclosure to provide a trace information acquisition apparatus capable of acquiring trace information, such as trace information regarding the quality of an in-process product in production processes and trace information regarding energy in production processes of a product, even in the fields not sharing an infrastructure.

It is yet another aspect of the present disclosure to provide a trace information acquisition program capable of acquiring trace information, such as trace information regarding the quality of an in-process product in production processes and trace information regarding energy in production processes of a product, even in the fields not sharing an infrastructure.

It is yet another aspect of the present disclosure to provide a recording medium storing the trace information acquisition program capable of acquiring trace information, such as trace information regarding the quality of an in-process product in production processes and trace information regarding energy in production processes of a product, even in the fields not sharing an infrastructure.

A trace information acquisition system, according to an aspect of the present disclosure, is provided for acquiring trace information regarding a product manufactured through a plurality of stages includes a storage unit (storage) that stores event data sets regarding events performed on the product; and a acquisition unit (acquirer) that acquires trace information from the event data sets stored by the storage unit. The event data sets stored at the plurality of stages have a common data format.

The event data sets regarding the events performed on the product in the plurality of stages have a common data format, thereby enabling acquisition of trace information of the product based on the stored event data sets. This makes it possible to acquire the trace information of a product manufactured through a plurality of stages irrespective of infrastructures. For example, the acquisition of the trace information of the product manufactured through the plurality of stages can be done without storing data required to associate the stages with one another. Even if, therefore, the product is manufactured in fields not sharing an infrastructure, trace information can be acquired.

Each of the event data sets may include object data related to the event, personnel data related to the event, time data related to the event, positional data related to the event and status data related to the event.

The storage unit stores event activity data sets that are business activity information required to be stored upon event occurrence, and the acquisition unit acquires trace information from the event activity data sets stored by the storage unit.

The acquisition unit includes an extraction unit (extractor) that extracts a plurality of event data sets associated with one another from a plurality of the event data sets stored by the storage unit.

In addition, the associated event data sets extracted from the plurality of the event data sets by the extraction unit are event data sets with the same time data related to the events.

According to another aspect of the disclosure, the storage unit stores the event data sets using an RFID (Radio Frequency Identification) tag.

In the trace information acquisition system for acquiring trace information regarding a product manufactured through a plurality of stages, the storage unit stores event data sets regarding the quality of an in-process product in production processes, and the acquisition unit acquires trace information regarding the quality of the in-process product in the production processes from the event data sets stored by the storage unit.

Each of the event data sets includes storage ID data related to a storage event for storing quality information of the in-process product in the production processes, personnel data related to the storage event for storing the quality information, time data related to the storage event for storing the quality information, positional data related to the storage event for storing the quality information, and status data related to the storage event for storing the quality information.

The storage unit stores event activity data sets that are business activity information required to be stored upon occurrence of the event for storing the quality information, and the acquisition unit acquires trace information regarding the quality of the in-process product in the production processes from the event activity data sets stored by the storage unit.

In addition, the associated event data sets extracted from the plurality of the event data sets by the extraction unit may be event data sets with the same positional data.

Furthermore, in the trace information acquisition system for acquiring trace information regarding a product manufactured through a plurality of stages, the storage unit stores event data sets regarding energy in production processes of a product, and the acquisition unit acquires trace information regarding energy in the production processes of the product from the event data sets stored by the storage unit.

Each of the event data sets includes measuring instrument data that including information about a measuring instrument used to measure energy, personnel data related to a person who measures the energy, time data related to time for measuring the energy, positional data related to a location where the energy is measured, and status data related to a status in energy measurement operations.

In another aspect of the present disclosure, a method is provided for acquiring trace information regarding a product manufactured through a plurality of stages includes storing event data sets regarding events performed on the product, the event data sets stored at the plurality of stages having a common data format; and acquiring trace information from the event data sets stored in the storing step.

The method for acquiring trace information regarding a product manufactured through a plurality of stages, event data sets regarding the quality of an in-process product in production processes are stored in the storing step, the event data sets stored at the plurality of stages having a common data format, and trace information regarding the quality of the in-process product in the production processes is acquired in the acquiring step from the event data sets stored in the storing step.

In addition, the method for acquiring trace information regarding a product manufactured through a plurality of stages can be configured so that event data sets regarding energy in production processes of a product are stored in the storing step, the event data sets stored at the plurality of stages having a common data format, and trace information regarding energy in the production processes of the product is acquired in the acquiring step from the event data sets stored in the storing step.

In yet another aspect of the present disclosure, the trace information acquisition apparatus for acquiring trace information regarding a product manufactured through a plurality of stages includes a storage section (storage) that stores event data sets regarding events performed on the product, the event data sets stored at the plurality of stages having a common data format; and an acquisition section (acquirer) that acquires trace information from the event data sets stored by the storage section.

Preferably, in the trace information acquisition apparatus for acquiring trace information regarding a product manufactured through a plurality of stages, the storage section stores event data sets regarding the quality of an in-process product in production processes, the event data sets stored at the plurality of stages having a common data format, and the acquisition section acquires trace information regarding the quality of the in-process product in the production processes from the event data sets stored by the storage section.

In addition, the trace information acquisition apparatus for acquiring trace information regarding a product manufactured through a plurality of stages can be configured so that the storage section stores event data sets regarding energy in production processes of a product, the event data sets stored at the plurality of stages having a common data format, and the acquisition section acquires trace information regarding energy in the production processes of the product from the event data sets stored by the storage section.

In yet another aspect of the present disclosure, a non-transitory computer readable medium is provided for storing a computer program for a trace information acquisition program that causes a computer to execute, in order to acquire trace information regarding a product manufactured through a plurality of stages storing event data sets regarding events performed on the product, the event data sets stored at the plurality of stages having a common data format, and acquiring trace information from the event data sets stored by the storage unit.

Preferably, the trace information acquisition program causes a computer to execute, in order to acquire trace information regarding a product manufactured through a plurality of stages storing event data sets regarding the quality of an in-process product in production processes, the event data sets stored at the plurality of stages having a common data format, and acquiring trace information regarding the quality of the in-process product in the production processes from the event data sets stored by the storage unit.

In addition, the trace information acquisition program may cause a computer to execute, in order to acquire trace information regarding a product manufactured through a plurality of stages storing event data sets regarding energy in production processes of a product, the event data sets stored at the plurality of stages having a common data format, and an acquiring trace information regarding energy in the production processes of the product from the event data sets stored by the storage unit.

The recording medium comprises a computer-readable recording medium that stores the aforementioned trace information acquisition program.

According to the trace information acquisition system, the event data sets related to events performed on a product are stored at a plurality of stages have a common data format, thereby enabling acquisition of trace information of the product based the stored event data sets. This makes it possible to acquire the trace information of the product manufactured through the plurality of stages irrespective of infrastructures. For example, the acquisition of the trace information of the product manufactured through the plurality of stages can be done without storing data required to associate the stages with one another. Even if, therefore, the product is manufactured in fields not sharing an infrastructure, trace information, such as trace information regarding the quality of an in-process product in production processes and trace information regarding energy in production processes of a product, can be acquired.

In addition, the method for acquiring trace information, trace information acquisition apparatus, and trace information acquisition program and recording medium can also acquire trace information of a product manufactured through a plurality of stages irrespective of infrastructures. For example, the acquisition of the trace information of the product manufactured through the plurality of stages can be done without storing data required to associate the stages with one another. Even if, therefore, the product is manufactured in fields not sharing an infrastructure, trace information, such as trace information regarding the quality of an in-process product in production processes and trace information regarding energy in production processes of a product, can be acquired.

### BRIEF DESCRIPTION OF THE DRAWINGS

FIG. 1 is a conceptual diagram representing event data.

FIG. 2 illustrates a hardware system configuration of a trace information acquisition system according to one embodiment of the present disclosure.

FIG. 3 is a flow chart showing an operation flow to store the event data.

FIG. 4 is a block diagram of the trace information acquisition system according to the embodiment of the disclosure.

FIG. 5 is a flow chart showing an operation flow to acquire product trace information.

FIG. 6 illustrates an example of the event data obtained during installation work for a product with a parts installation machine provided with an attachment part, or a reel.

FIG. 7 illustrates the relation of the event data shown in FIG. 6.

FIG. 8 illustrates examples of event data in manufacturing processes from product ordering to shipment.

FIG. 9 is a conceptual diagram representing event data regarding quality information of a product in a production process.

FIG. 10 is a block diagram of a trace information acquisition system according to another embodiment of the disclosure.

FIG. 11 is a flow chart showing an operation flow to acquire product trace information.

FIG. 12 is a conceptual diagram showing the relation between event data regarding the quality information about a product in a production process and event data regarding a product process of a product.

FIG. 13 illustrates an example of event data obtained during installation of a product.

FIG. 14 illustrates the relation of the event data shown in FIG. 13.

FIG. 15 is a conceptual diagram of event data about a power consumption monitoring event performed to monitor the power consumed in a production process of a product.

FIG. 16 is a flow chart showing an operation flow to acquire trace information of a product.

FIG. 17 illustrates an example of event data obtained during installation of a product.

### DETAILED DESCRIPTION

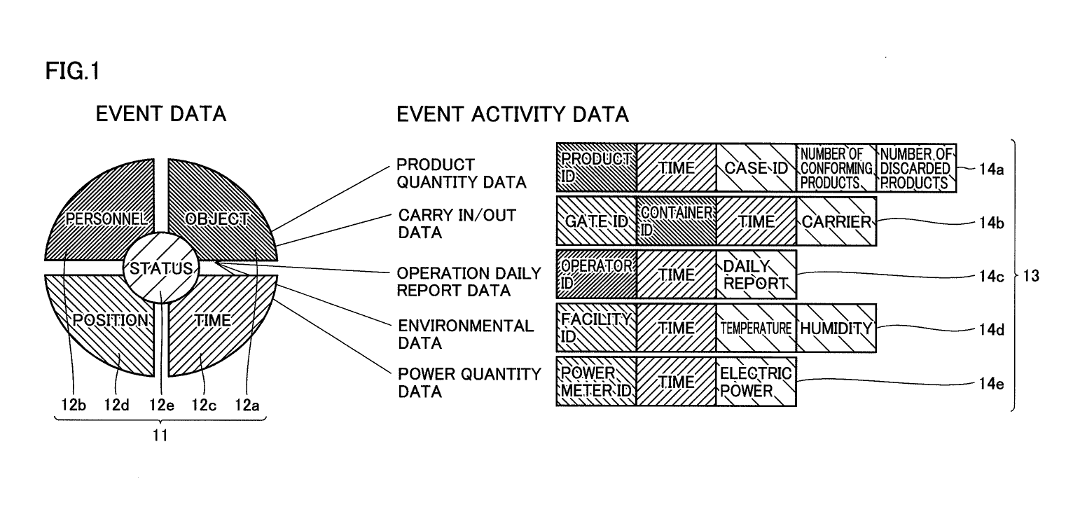

With reference to the drawings, descriptions will be made about embodiments of the present disclosure. At first, event data used in a trace information acquisition system according to one embodiment of the disclosure will be described. FIG. 1 is a conceptual diagram representing the data format of the event data. Referring now to FIG. 1, an event data set 11 describes an event that was performed on a product and is stored in a common data format at every product manufacturing stage. The event data set 11 contains object data 12a which is information about an object to be sensed in an event, personnel data 12b which is information about a person related to the event, time data 12c which is information about time related to the event, positional data 12d which is information about a location related to the event and status data 12e which is information about a status related to the event. The object data 12a, personnel data 12b, time data 12c and positional data 12d are conceptually linked to one another via the status data 12e.

Next, an event activity data set 13 will be described. The event activity data set 13 refers to business activity information required to be stored upon event occurrence, such as product quantity data and part consumption data. The event activity data set 13 is composed of data items attributing to events at each field. For example, a product quantity data set 14a of the event activity data set 13 includes “product ID” attributing to the object data and “time” attributing to the time data. “Case ID”, “number of conforming products” and “number of discarded products” are on-site input/acquisition information. A carry in/out data set 14b includes “gate ID” attributing to the positional data, “container ID” attributing to the object data, “time” attributing to the time data, and “carrier” being the on-site input/acquisition information. A operation daily report data set 14c includes “operator ID” attributing to the personnel data, “time” attributing to the time data, and “daily report” being the on-site input/acquisition information. An environmental data set 14d includes “facility ID” attributing to the positional data, “time” attributing to the time data, and “temperature” and “humidity” being the on-site input/acquisition information. A power quantity data set 14e includes “power meter ID” attributing to the positional data, “time” attributing the time data, and “electric power” being the on-site input/acquisition information. The event activity data set is associated with event data set with a minimum of data items to achieve a 1:1 correlation therebetween. In the event activity data sets in FIG. 1, the data items attributing to the same event data, such as object data, have the same hatch patterns.

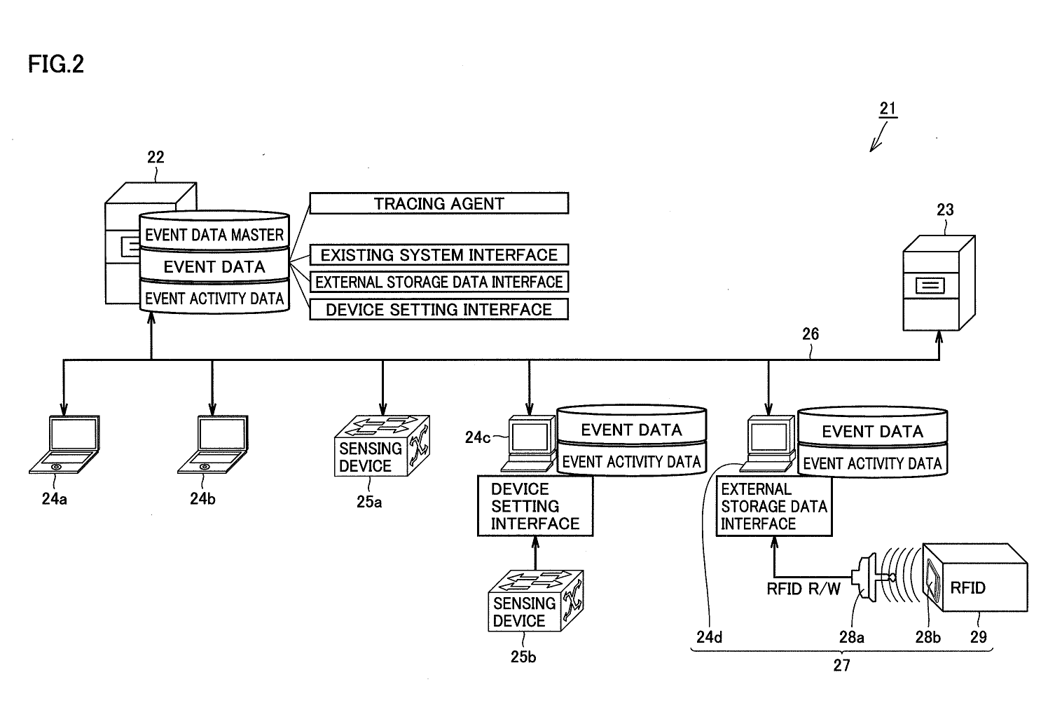

FIG. 2 illustrates a hardware system configuration of the trace information acquisition system according to one embodiment of the present disclosure. Referring to FIGS. 1 and 2, the trace information acquisition system 21 includes a server 22 capable of storing various types of data, such as the event data, event activity data and an event data master containing a plurality of event data sets and event activity data sets, a server 23 constructing an existing system and storing production-management related data, a process master and BOM (Build Of Material) master, computers 24a, 24b, 24c, 24d used to input data including the event data, a sensing device 25a enabling direct input of the event data, a sensing device 25b enabling input of the event data via the computer 24c, and a connecting line 26 connecting the servers 22, 23 and computers 24a to 24d. The server 22 includes storage unit to store event data regarding events performed on a product and acquisition unit to acquire trace information from the event data stored by the storage unit. The computer 24c functions as a device setting interface for the sensing device 25b. The trace information acquisition system 21 also includes an RFID tag system 27 capable of inputting and outputting event data of a remotely placed product. The RFID tag system 27 includes a reader/writer 28a provided to the computer 24d and an RFID tag 28b that is attached on a product 29 and is readable and writable, in other words, containing data in which the reader/writer 28a can input and output. The computer 24d functions as an external storage data interface for the RFID tag system 27.

The servers 22 and 23 can be implemented in one server. The connecting line 26 is not limited to wired communication, but can be partially or entirely implemented by wireless communication. The four computers 24a to 24d are used herein, but the number of the computers is not limited to four and one or more computers can be used. The trace information acquisition system does not need to include the sensing devices 25a, 25b and RFID tag system 27, or can include two or more, respectively.

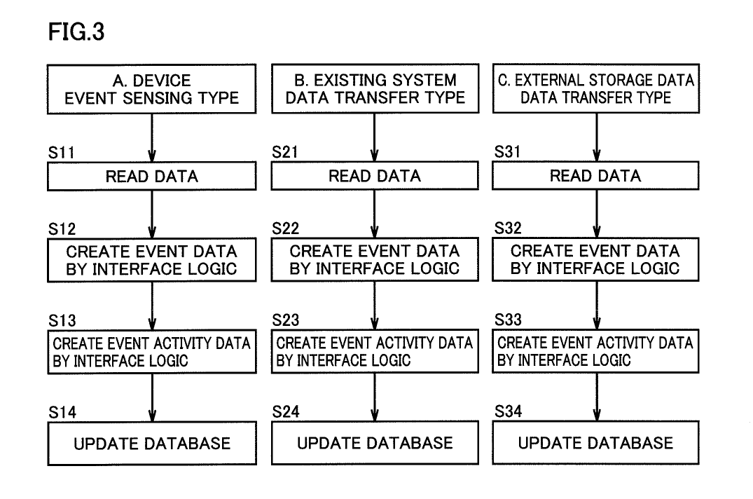

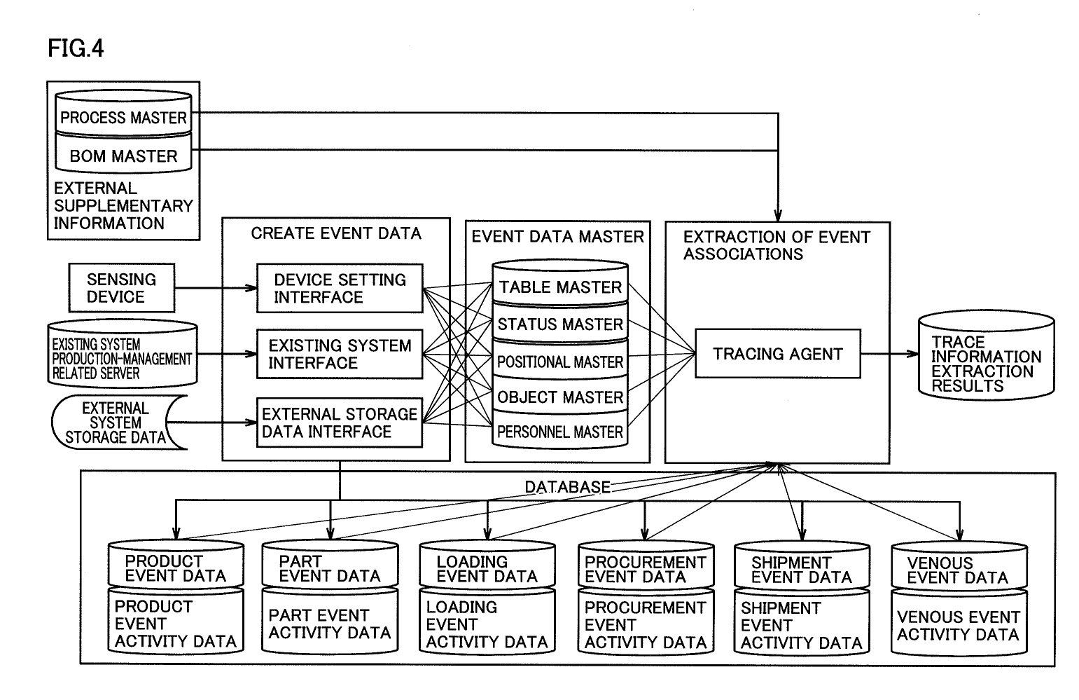

A description will be now made about a method for storing event data about events performed on a product. FIG. 3 is a flow chart showing an operation flow to store event data. FIG. 4 is a block diagram of the trace information acquisition system according to the embodiment of the disclosure. The first method described with FIGS. 1 to 4 is a method for storing event-sensing type event data with devices. The method is to directly acquire event data from sensing devices, such as the sensing devices 25a and 25b in the system configuration view of FIG. 2, and to store the event data.

At first, data is captured from the sensing device (device) 25b through the device setting interface of the computer 24c (step S11 in FIG. 3, the “step” is hereinafter omitted). Secondly, event data with the above-described structure is created by the interface logic of the computer 24c (S12). Subsequently, event activity data with the above-described structure is created by the interface logic of the computer 24c (S13). Thirdly, databases of the event data master stored in the server 22 are updated (S14). The event data master updated in this embodiment includes a table master, status master, positional master, object master and personnel master. The database updates are equivalent to storing new event data into respective masters.

The event data master herein is used to associate the data of the event data with the contents of the event data. For example, personnel data is stored in the form of simple symbols, such as numerals and letters of alphabet. The personnel master in the event data master stores the association between the symbol and information, such as the name of an actual operator and the department the operator belongs to. The status master, positional master and object master are also structured in the same manner. The table master is available for various databases of product event data, part event data and so on. Note that the time data is represented simply by year, month, day and time and does not need to associate with other information, and therefore there is no master for time data.

Next, a method for storing data-transfer type event data with an existing system will be described. The method for storing data-transfer type event data refers to a method for storing event data that is converted from data retrieved from a storage device in an existing system such as the server 23 as shown in the system configuration of FIG. 2, and a method for storing event data that is converted from data retrieved from an external storage medium such as the RFID tag 28b as shown in the system configuration.

Firstly, the server retrieves data from the production-management related server 23, which constructs an existing system (S21). Secondly, event data and event activity data are created by the interface logic of the existing system interface of the server 22 (S22, S23). Thirdly, databases of the event data master stored in the server 22 are updated (S24).

Next, a method for storing data-transfer type event data with external storage data will be described. The computer 24d captures data through the RFID tag system 27 (S31). Specifically, external-system storage data is captured from the RFID tag 28b attached on a product 29 by the reader/writer 28a and is input into the computer 24d. Then, event data and event activity data are created by the interface logic of an external storage data interface of the computer 24d (S32, S33). Subsequently, databases of the event data master stored in the server 22 are updated (S34).

In the above-mentioned manner, event data and event activity data are created with various types of data, i.e., the event-sensing type data obtained by the devices, data-transfer type data obtained from the existing system, and data-transfer type data obtained from the external storage data and are stored to update the databases.

As shown in FIG. 4, various databases can be built in advance based on event data. Specific databases include product event data sets and product event activity data sets regarding a product and stored at a plurality of stages, parts event data sets and parts event activity data sets regarding a part, loading event data sets and loading event activity data sets regarding loading, procurement event data sets and procurement event activity data sets regarding procurement, shipment event data sets and shipment event activity data sets regarding shipment, and venous event data sets and venous event activity data sets regarding veins. Note that the venous event is not related to the production processes of a product, but to reclamation, dismantlement, reuse and recycling. The construction of the databases makes the acquisition of trace information, which will be described later, more suitable and more efficient.

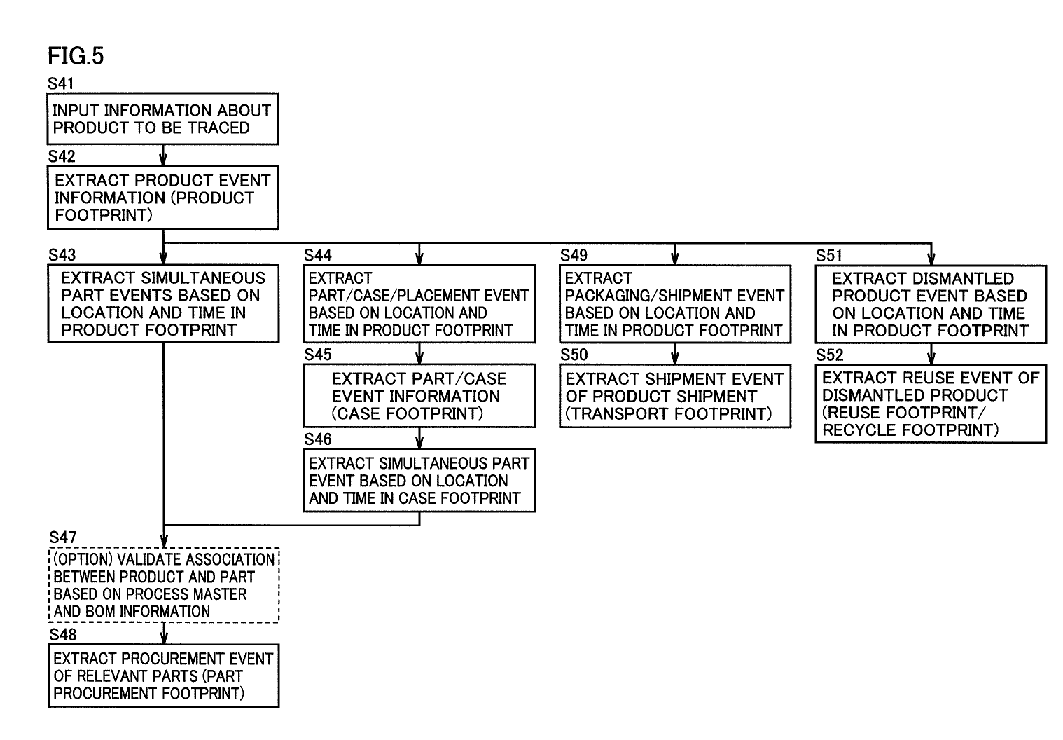

A method for acquiring trace information of a product with event data will be described. FIG. 5 is a flow chart showing an operation flow to acquire the product trace information. Referring now to FIGS. 1 to 5, upon input of information, serving as a tracing agent, of a target product whose trace information is intended to be acquired into the server 22 (S41), event data sets of the product manufactured through a plurality of stages are extracted (S42). The acquisition unit in the server 22 includes extraction unit to extract a plurality of event data sets related to one another from a plurality of event data sets stored by the storage unit. The event data sets of a product in this description are so-called footprint information of the product, which represents what processes the product has undergone.

Next, based on the extracted product event data sets, more specifically, based on time data and positional (location) data in the event data sets, simultaneously occurring parts events, that is, part events with the same time data and positional data are extracted (S43). In the extraction, the extraction unit extracts, from the plurality of event data sets, event data sets whose time data represent the same point of time as associated event data sets. Similarly, based on the extracted product event data sets, a part/case/placement event is extracted (S44), and then a part/case event is extracted from the extracted part/case/placement event (S45), and a part event is extracted from the extracted part/case event (S46). After the information of the part event extracted at S43 and the part/case/placement event, part/case event and part event extracted at S44 to S46, respectively, are validated based on the process master and the BOM information of the BOM master (S47), a procurement event, which is a related event, is extracted (S48). Note that the validation step performed with the process master and BOM master is optional.

In addition, after the extraction of the product event information at S42, a packaging/shipment event is extracted together with the part event (S49), and then a shipment event related to product shipment is extracted (S50). Similarly, after the extraction of the product event information at S42, a dismantled product event is extracted together with the part event (S51), and then a reuse event for the dismantled product is extracted (S52).

In the above-described manner, trace information, more specifically, information about relevant parts to the product, part information and information about the case, shipment and reuse are acquired from the event data sets. According to the trace information acquisition system, the event data sets about events performed on a product in a plurality of stages have a common data format, thereby enabling acquisition of trace information of the product from the stored event data sets. This allows the acquisition of trace information regarding a product manufactured through a plurality of stages irrespective of infrastructures. For example, the acquisition of the trace information of a product manufactured through a plurality of stages can take place without storing data used to associate the stages with one another. Even if, therefore, the product is manufactured in fields not sharing an infrastructure, trace information of the product can be acquired.

The trace information acquisition system stores a process to which a product to be traced is subjected in its life cycle as event data defining the start and end of the process. Simultaneously, the trace information acquisition system stores event data regarding part/component consumption and packaging and shipment that have taken place at the same place and time in the life cycle process of the product. The simultaneity of the events can create associations among the parts and components used to manufacture the product and also associations with a parts/components receiving process and a product shipment process, thereby acquiring trace information regarding from procurement of the parts and components to production and shipment of the product. In addition to the production processes, the simultaneity can create associations among the venous events including reclamation, dismantlement, reuse and recycling. Even for the venous events, the event data sets stored in a common data format at a plurality of stages make it possible to acquire trace information.

There are a product life cycle footprint and a carbon footprint as trace information representation. A product leaves traces of its existence across procurement, production, use, reclamation, dismantlement, reuse and recycling, and the traces and tracks are referred to as a product life cycle footprint. Records of amounts of CO₂ (carbon dioxide) emitted in respective traces result in the tracking of CO₂ emissions in the product life cycle footprint, which is referred to as a carbon footprint.

The method for acquiring trace information according to the disclosure is to acquire trace information of a product manufactured through a plurality of stages and includes a step of storing event data sets about events performed on the product, the event data sets stored at the plurality of stages having a common data format, and a step of acquiring trace information from the event data sets stored in the storing step.

A trace information acquisition apparatus according to the disclosure is to acquire trace information regarding a product manufactured through a plurality of stages and includes a storage section storing event data sets regarding events performed on the product, the event data sets stored at the plurality of stages having a common data format, and an acquisition section acquiring trace information from the event data sets stored by the storage section. The trace information acquisition apparatus corresponds to the server 22 in FIG. 2.

A trace information acquisition program causes a computer, in order to acquire trace information regarding a product manufactured through a plurality of stages, to function as storage unit storing event data sets about events performed on the product, the event data sets stored at the plurality of stages having a common data format, and acquisition unit acquiring trace information from the event data sets stored by the storage unit.

A recording medium according to the disclosure is a computer-readable recording medium storing the trace information acquisition program.

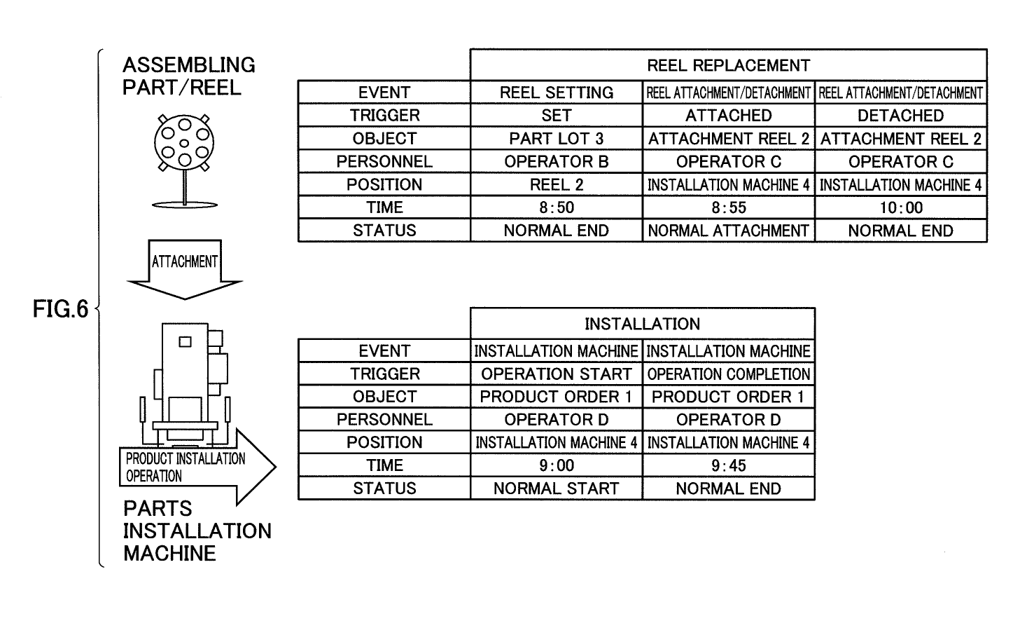

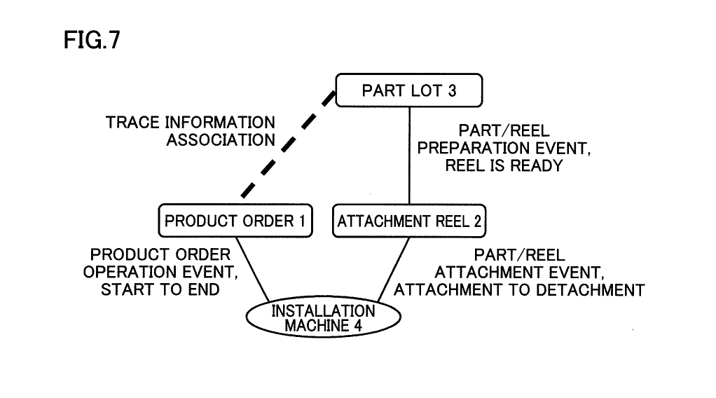

A description will be made about the embodiment of the trace information acquisition system according to the present disclosure. FIG. 6 illustrates an example of event data obtained when a product is assembled by a parts installation machine with an assembling part, or a reel placed therein. FIG. 7 illustrates event data associations in the case shown in FIG. 6. Referring to FIGS. 6 and 7, reel replacement involves: a reel setting event whose trigger specifies “set”, in other words, an event of “tape (part) being set to the reel”; a reel attachment/detachment event whose trigger specifies “attached”, in other words, an event of “the reel being attached to or detached from the parts installation machine”; and a reel attachment/detachment event whose trigger specifies “detached”. For these events, event data sets as shown in FIG. 6 are stored. Specifically, the “reel setting” event with the trigger specifying “set” stores object data of “part lot 3”, personnel data of “operator B”, positional (facility) data of “reel 2”, time data of “8:50”, and status data of “normal end”. This means that the operator B properly the set part lot 3 into the reel 2 at 8:50. Similarly, the “reel attachment/detachment” event with the trigger specifying “attached” stores object data of “attachment reel 2”, personnel data of “operator C”, positional (facility) data of “installation machine 4”, time data of “8:55”, and status data of “normal attachment”. This means that the operator C properly attached the reel 2 to the installation machine 4 at 8:55. Furthermore, similarly, the “reel attachment/detachment” event with the trigger specifying “detached” stores object data of “attachment reel 2”, personnel data of “operator C”, positional (facility) data of “installation machine 4”, time data of “10:00”, and status data of “normal end”. This means that the operator C properly detached the reel 2 from the installation machine 4 at 10:00.

In addition, installation involves an “installation machine” event whose trigger specifies “operation start” and an “installation machine” event whose trigger specifies “operation completion”. As shown in FIG. 6, the “installation machine” event with the trigger specifying “start operations” stores object data of “product order 1”, personnel data of “operator D”, positional (facility) data of “installation machine 4”, time data of “9:00”, and status data of “normal start”. This means that the operator D properly started an installation operation for the product order 1 with the installation machine 4 at 9:00. The “installation machine” event with the trigger specifying “finish operations” stores object data of “product order 1”, personnel data of “operator D”, positional (facility) data of “installation machine 4”, time data of “9:45”, and status data of “normal end”. This means that the operator D properly finished the installation operation for the product order 1 with the installation machine 4 at 9:45.

After the acquisition of the pieces of trace information, the trace information pieces are associated with each other as shown by a dotted line in FIG. 7. Specifically, the object data in the event data sets regarding the installation machine 4 specifies “product order 1”. In addition, the positional data in the event data sets regarding the reel attachment/detachment specifies “installation machine 4”. Furthermore, the object data in the reel attachment/detachment event data sets specifies “attachment reel 2”, while the positional data in the reel setting event specifies “reel 2”.

As shown in FIG. 7, the trace information of the part lot 3 and product order 1 can be associated by the event data sets via the installation machine 4 and attachment reel 2 without storing the direct associations between the part lot 3 and product order 1.

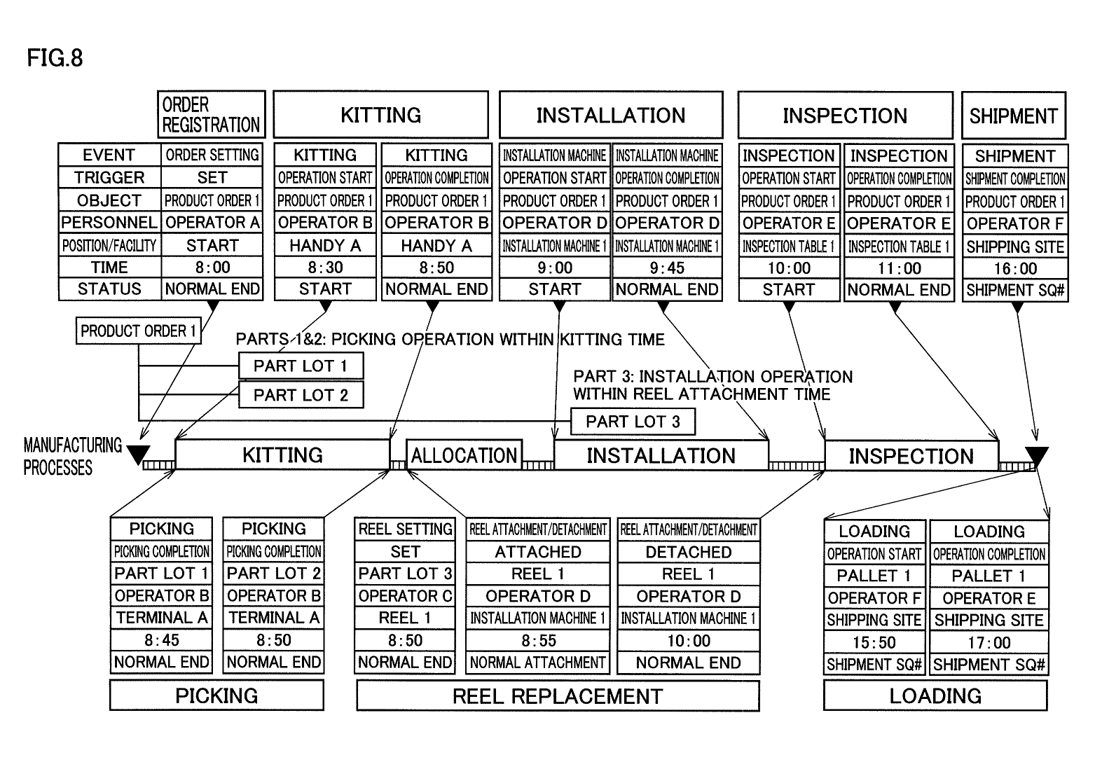

Further description about the event data in manufacturing processes will be now made as another embodiment. FIG. 8 illustrates an example of event data created in manufacturing processes from product ordering to shipment. Referring to FIG. 8, the manufacturing processes include a picking process for choosing parts from stocks for a product order, a kitting process for arranging the picked parts so that assembling operators can easily assemble them, a reel replacement process, an allocation process, an installation process, an inspection process, and a loading process. Prior to the picking process, an order registration event whose trigger specifies “set” is performed. For the events occurring in these respective processes, event data sets including object data, personnel data, positional data, time data and status data are stored. Then, trace information is acquired from the stored event data sets.

The trace information acquisition system can acquire trace information regarding a product manufactured through a plurality of stages irrespective of infrastructures. For example, the acquisition of the trace information of the product manufactured through the plurality of stages can take place without storing data required to associate the stages with one another. Even if, therefore, the product is manufactured in fields not sharing an infrastructure, trace information of the product can be acquired.

The method for acquiring trace information, the trace information acquisition apparatus, and the trace information acquisition program and recording medium can also acquire trace information of a product manufactured through a plurality of stages irrespective of infrastructures. For example, the acquisition of trace information of a product manufactured through a plurality of stages can take place without storing data required to associate the stages with one another. Even if, therefore, the product is manufactured in fields not sharing an infrastructure, trace information of the product can be acquired.

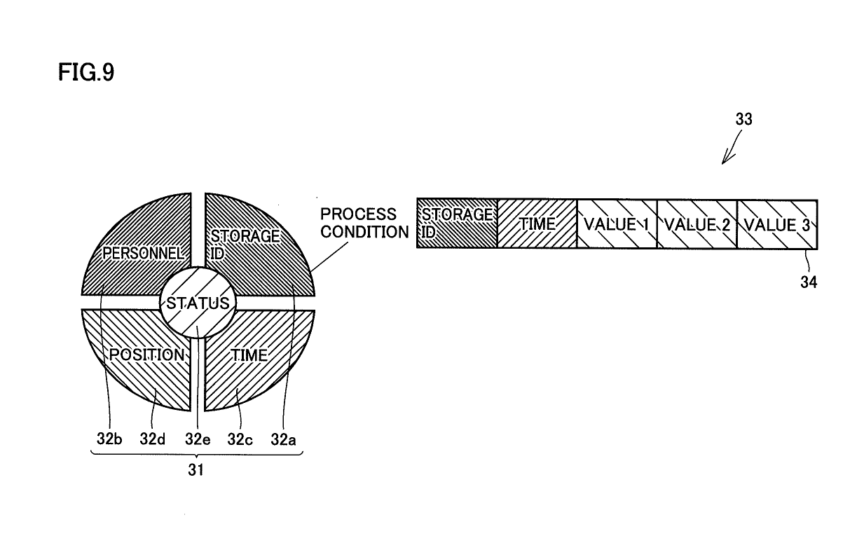

Another embodiment of the present disclosure will be described. First, a description will be made about event data used in the trace information acquisition system according to the embodiment of the disclosure. FIG. 9 is a conceptual diagram representing the data format of event data related to quality information of a product in a production process. Referring to FIG. 9, an event data set 31 describes a quality information storage event that was performed to store quality information of a product manufactured through a plurality of stages. The event data set is stored in a common data format at every product manufacturing stage. The event data set 31 contains storage ID data 32a which is information about a storage event performed to store quality information of the product to be sensed, personnel data 32b which is information about a person involved in the quality information storage event, time data 32c which is time information related to the quality information storage event, positional data 32d which is location information related to the quality information storage event, and status data 32e which is status information related to the quality information storage event. The storage ID data 32a, personnel data 32b, time data 32c and positional data 32d are conceptually linked to one another via the status data 32e.

Next, an event activity data set 33 will be described. The event activity data 33 refers to business activity information required to be stored upon occurrence of storage events for storing quality information of an in-process product in production processes. The event activity data set 33 is composed of data items attributing to events at each field. For example, a process condition data set 34 of the event activity data set 33 includes “storage ID” attributing to storage ID data and “time” attributing to time data. “Value 1”, “value 2” and “value 3” are on-site input/acquisition information. The event activity data set is linked with event data set with a minimum of data items to achieve a 1:1 correlation therebetween. In the event activity data set in FIG. 9, the data items attributing to the same event data, such as storage ID data, have the same hatch patterns.

FIG. 2 illustrates a hardware system configuration of the trace information acquisition system according to the embodiment of the present disclosure. Referring to FIGS. 2 and 9, the trace information acquisition system 21 includes a server 22 capable of storing various types of data, such as the event data, event activity data and an event data master containing a plurality of event data sets and event activity data sets, a server 23 constructing an existing system and storing production-management related data, a process master and BOM (Build Of Material) master, computers 24a, 24b, 24c, 24d used to input data including the event data, a sensing device 25a enabling direct input of the event data, a sensing device 25b enabling input of the event data via the computer 24c, and a connecting line 26 connecting the servers 22, 23 and computers 24a to 24d. The server 22 includes storage unit to store event data regarding the quality of an in-process product in production processes and acquisition unit to acquire trace information regarding the quality of the product in the production processes from the event data stored by the storage unit. The computer 24c functions as a device setting interface for the sensing device 25b. The trace information acquisition system 21 also includes an RFID tag system 27 capable of inputting and outputting event data of a remotely placed product. The RFID tag system 27 includes a reader/writer 28a provided to the computer 24d and an RFID tag 28b that is attached on a product 29 and is readable and writable, in other words, containing data in which the reader/writer 28a can input and output. The computer 24d functions as an external storage data interface for the RFID tag system 27.

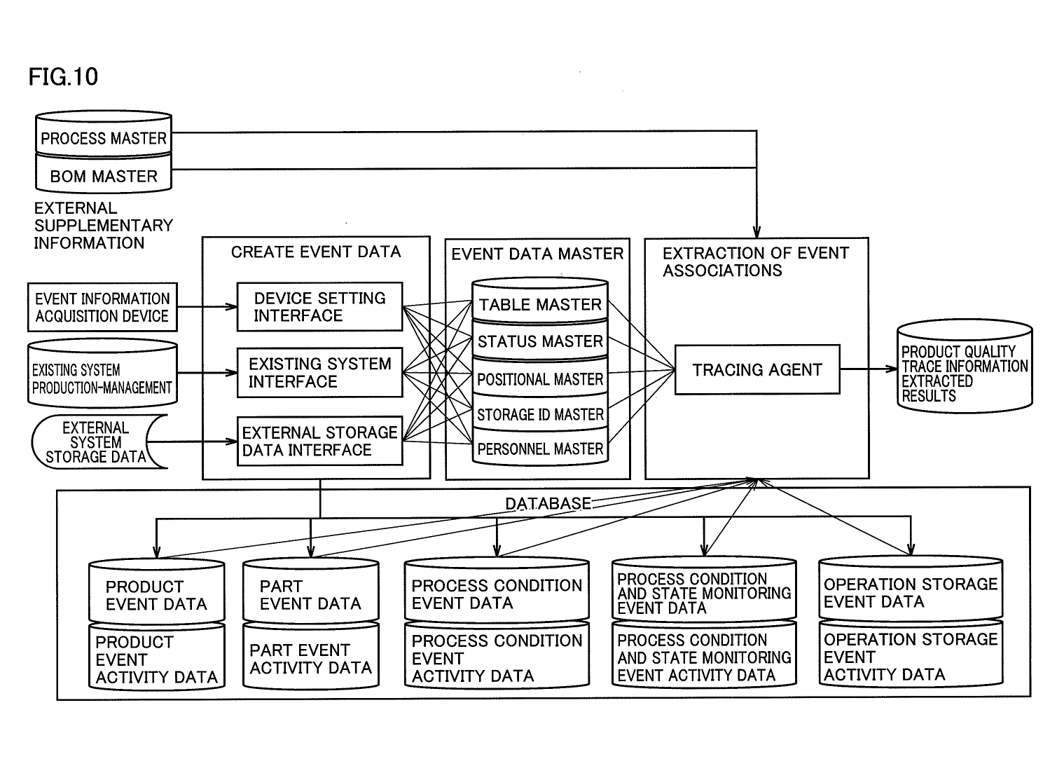

A description will be now made about a method for storing event data about the quality of a product in production processes by referring FIG. 3 described above. FIG. 10 is a block diagram of the trace information acquisition system according to the embodiment of the disclosure. The first method described with FIG. 10 and some other drawings is a method for storing event-sensing type event data with devices. The method is to directly acquire event data from sensing devices, such as the sensing devices 25a and 25b in the system configuration view of FIG. 2, and to store the event data.

At first, data is captured from the sensing device (device) 25b through the device setting interface of the computer 24c (step S11 in FIG. 3, the “step” is hereinafter omitted). Secondly, event data with the above-described structure is created by the interface logic of the computer 24c (S12). Subsequently, event activity data with the above-described structure is created by the interface logic of the computer 24c (S13). Thirdly, databases of the event data master stored in the server 22 are updated (S14). The event data master updated in this embodiment includes a table master, status master, positional master, storage ID master and personnel master. The database updates are equivalent to storing new event data into respective masters.

The event data master herein is used to associate the data of the event data with the contents of the event data. For example, personnel data is stored in the form of simple symbols, such as numerals and letters of alphabet. The personnel master in the event data master stores the association between the symbol and information, such as the name of an actual operator and the department the operator belongs to. The status master, positional master and storage ID master are also structured in the same manner. The table master is available for various databases of process condition event data, process condition and state monitoring event data, operation storage event data, and so on. Note that the time data is represented simply by year, month, day and time and does not need to associate with other information, and therefore there is no master for time data.

The same method for storing data-transfer type event data with an existing system is adopted in this embodiment, and therefore the descriptions thereof will not be reiterated.

As shown in FIG. 10, various databases can be built in advance based on event data. Specific databases include process condition event data and process condition event activity data regarding conditions imposed on processes, process condition and state monitoring event data and process condition and state monitoring event activity data regarding monitoring of the process conditions and states, and operation storage event data and operation storage event activity data regarding operation storage. The construction of the databases makes the acquisition of trace information, which will be described later, more suitable and more efficient.

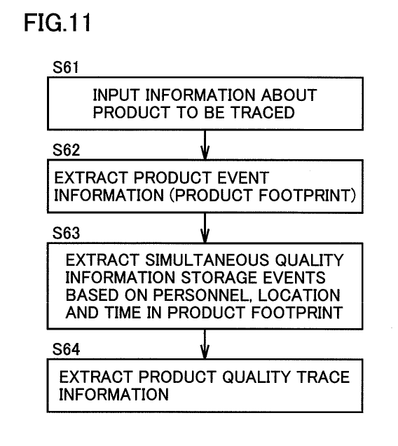

A method for acquiring trace information regarding the quality of an in-process product in production processes with event data will be described. FIG. 11 is a flow chart showing an operation flow to acquire the trace information regarding the quality of an in-process product in a production process. Referring now to FIG. 11 and some other drawings, upon input of information, serving as a tracing agent, of a target product whose trace information is intended to be acquired into the server 22 (S61), event data sets regarding the quality of the in-process product, which is manufactured through a plurality of stages, in a production processes are extracted (S62). The acquisition unit in the server 22 includes extraction unit to extract a plurality of event data sets related to one another from a plurality of event data sets stored by the storage unit. The event data regarding the quality of the product in the production processes in this description is so-called footprint information of the product quality, which represents what quality the product had in the production process.

Next, based on the extracted product event data sets, for example, based on personnel data, time data and positional (location) data in the event data sets, simultaneously occurring events involving one and the same person, that is, quality information storage events with the same personnel data, the same time data and the same positional data are extracted (S63). In the extraction, the extraction unit extracts, from the plurality of event data sets, event data sets having the same positional data as associated event data sets. In this manner, trace information regarding the quality of the in-process product in the production processes is acquired from the event data sets (S64).

According to the trace information acquisition system, the event data sets about the quality of an in-process product in a production processes are stored in a common data format at a plurality of stages, thereby enabling acquisition of trace information regarding the quality of the in-process product in the production processes based on the stored event data sets. This allows the acquisition of trace information regarding the quality of the in-process product, which is manufactured through the plurality of stages, in the production processes irrespective of infrastructures. For example, the acquisition of the trace information regarding the quality of a product, which is manufactured through a plurality of stages, in a production processes can take place without storing data required to associate the stages with one another. Even if, therefore, the product is manufactured in fields not sharing an infrastructure, trace information regarding the quality of the in-process product in the production processes can be acquired.

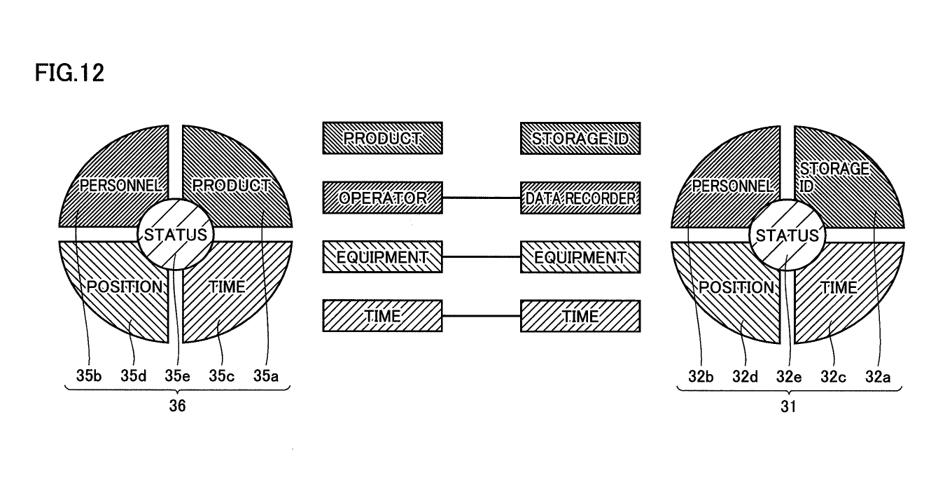

The trace information acquisition system may be configured to store a process to which a product to be traced is subjected in its life cycle as event data defining the start and end of the process and quality information of the product in the production process, and stores the both of them in the form of an event data set and an event activity data set. More specifically, as shown in FIG. 12, product data 35a regarding a product to be sensed, personnel data 35b regarding a person, time data 35c regarding time, positional data 35d regarding a position (location), and status data 35e regarding a status included in a product production process event data set 36 are configured to associate with the storage ID data 32a, personnel data 32b, time data 32c, positional data 32d and status data 32e included in the event data set 31 related to the quality information of the product in the production process.

More specifically, with agreement between the personnel data 35b describing an operator and the personnel data 32b describing a data recorder, between the positional data 35d describing equipment and the positional data 32d describing equipment, and between the time data 35c describing time and the time data 32c describing time, the product data 35a in the production process and the storage ID data 32a related to the product quality can be associated with each other. Accordingly, the stored quality information containing data of the same person, the same location and the same time in the production processes of the product can be extracted as product quality trace information. Similarly, quality trace information can be acquired for venous events, such as reclamation, dismantlement, reuse and recycling. FIG. 12 is a conceptual diagram showing the associations between event data related to the quality information of a product in a process and event data regarding the process of the product. In this case, databases as shown in FIG. 10 can be constructed with product event data and product event activity data about the product and parts event data and parts event activity data about parts.

There are a product life cycle footprint and a carbon footprint as trace information representation. A product leaves traces of its existence across procurement, production, use, reclamation, dismantlement, reuse and recycling, and the traces and tracks are referred to as a product life cycle footprint. Records of amounts of CO₂ (carbon dioxide) emitted in respective traces result in the tracking of CO₂ emissions in the product life cycle footprint, which is referred to as a carbon footprint.

The method for acquiring trace information according to the disclosure is to acquire trace information regarding a product manufactured through a plurality of stages and includes a step of storing event data sets about the quality of an in-process product in production processes, the event data sets stored at the plurality of stages having a common data format, and an step of acquiring trace information regarding the quality of the product in the production processes from the event data sets stored in the storage step.

A trace information acquisition apparatus according to the disclosure is to acquire trace information regarding a product manufactured through a plurality of stages and includes a storage section storing event data sets regarding the quality of an in-process product in production processes, the event data sets stored at the plurality of stages having a common data format, and an acquisition section acquiring trace information regarding the quality of the in-process product in the production processes from the event data sets stored by the storage section. The trace information acquisition apparatus corresponds to the server 22 in FIG. 2.

A trace information acquisition program according to the disclosure causes a computer, in order to acquire trace information regarding the quality of an in-process product, which is manufactured through a plurality of stages, in production processes to function as storage unit storing event data sets regarding the quality of the product in the production processes, the event data sets stored at the plurality of stages having a common data format, and acquisition unit acquiring trace information regarding the quality of the product in the production processes from the event data sets stored by the storage unit.

A recording medium according to the disclosure is a computer-readable recording medium storing the trace information acquisition program.

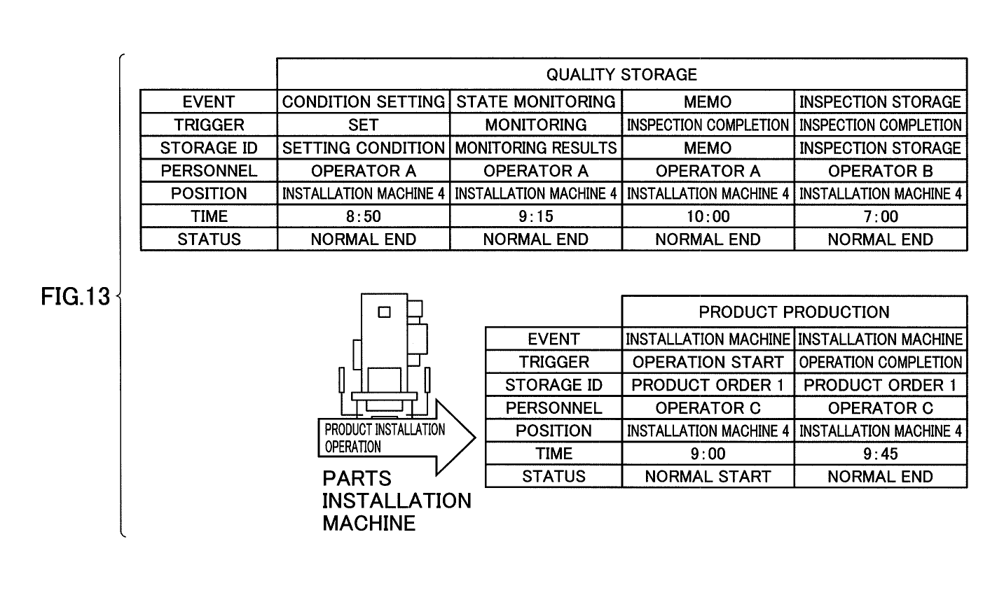

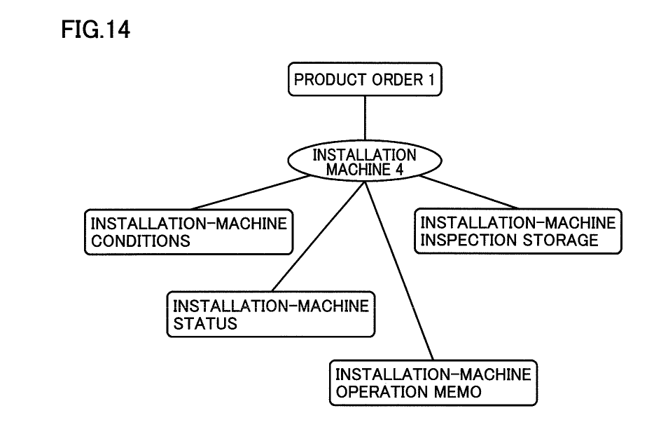

A description will be made about another embodiment of the trace information acquisition system according to the present disclosure. FIG. 13 illustrates an example of event data obtained during operations for assembling a product. FIG. 14 illustrates event data associations in the case shown in FIG. 13. Referring to FIGS. 13 and 14, the operations for installing the product with a parts installation machine include quality storage operations that involves: a “condition setting” event whose trigger specifies “set”; a “state monitoring” event whose trigger specifies “monitoring”; a “memo” event whose trigger specifies “inspection completion”; and an “inspection storage” event whose trigger specifies “inspection completion”. For these events, event data sets as shown in FIG. 12 are stored.

Specifically, the “condition setting” event with the trigger specifying “set” stores storage ID data of “setting condition”, personnel data of “operator A”, positional data of “installation machine 4”, time data of “8:50”, and status data of “normal end” as an event data set. This means that the operator A properly set conditions to the installation machine 4 at 8:50. Similarly, the “state monitoring” event with the trigger specifying “monitoring” stores storage ID data of “monitoring results”, personnel data of “operator A”, positional data of “installation machine 4”, time data of “9:15”, and status data of “normal end” as an event data set. This means that the operator A properly finished storing the monitoring results with the installation machine 4 at 9:15. Similarly, the “memo” event with the trigger specifying “inspection completion” stores storage ID data of “memo”, personnel data of “operator A”, positional data of “installation machine 4”, time data of “10:00”, and status data of “normal end” as an event data set. This means that the operator A properly finished storing the memo with the installation machine 4 at 10:00. Similarly, the “inspection storage” event with the trigger specifying “inspection completion” stores storage ID data of “inspection storage”, personnel data of “operator B”, positional data of “installation machine 4”, time data of “7:00”, status data of “normal end” as an event data set. This means that the operator B properly finished the inspection storage with the installation machine 4 at 7:00.

In addition, the production processes of the product involve an “installation machine” event whose trigger specifies “operation start” and an “installation machine” event whose trigger specifies “operation completion”. As shown in FIG. 12, the “installation machine” event with the trigger specifying “operation start” stores object data of “product order 1”, personnel data of “operator C”, positional data of “installation machine 4”, time data of “9:00”, and status data of “normal start” as an event data set. This means that the operator C properly started issuing the product order 1 to the installation machine 4 at 9:00. Similarly, the “installation machine” event with the trigger specifying “operation completion” stores object data of “product order 1”, personnel data of “operator C”, positional data of “installation machine 4”, time data of “9:45”, and status data of “normal end” as an event data set. This means that the operator C properly finished issuing the product order 1 to the installation machine 4 at 9:45.

After the acquisition of the pieces of trace information, the trace information pieces regarding the quality of the in-process product in the production processes are associated with one another as shown by solid lines in FIG. 14. Specifically, all of the positional data in the event data sets related to the installation machine 4 hold “installation machine 4”. From the information of the event data sets, trace information pieces regarding the quality of the in-process product in the production processes can be associated with one another without storing the direct associations among the “condition setting” event, “state monitoring” event, “memo” event, and “inspection storage” event. More specifically, “installation-machine conditions” information derived from the “condition setting” event, “installation-machine status” information derived from the “state monitoring” event, “installation-machine operation memo” information derived from the “memo” event and “installation-machine inspection storage” information derived from the “inspection storage” event can be acquired as trace information regarding the quality of the in-process product in the production processes.

The additional associations can be created using the event data sets of the production process of the product. Specifically, the event data sets involved in the quality storage are associated with the event data sets involved in the product production via “installation machine 4” of the positional data in FIG. 13, and the associated event data sets can be used to derive trace information.

The trace information acquisition system can acquire trace information regarding the quality of the in-process product, which is manufactured through a plurality of stages, in the production processes irrespective of infrastructures. For example, the acquisition of the trace information regarding the quality of the in-process product, which is manufactured through the plurality of stages, in the production processes can take place without storing data required to associate the stages with one another. Even if, therefore, the product is manufactured in fields not sharing an infrastructure, trace information regarding the quality of the in-process product in the production processes can be acquired.

The method for acquiring trace information, the trace information acquisition apparatus, and the trace information acquisition program and recording medium can also acquire trace information regarding the quality of the in-process product, which is manufactured through a plurality of stages, in the production processes irrespective of infrastructures. For example, the acquisition of the trace information regarding the quality of the in-process product, which is manufactured through the plurality of stages, in the production processes can take place without storing data required to associate the stages with one another. Even if, therefore, the product is manufactured in fields not sharing an infrastructure, trace information regarding the quality of the in-process product in the production processes can be acquired.

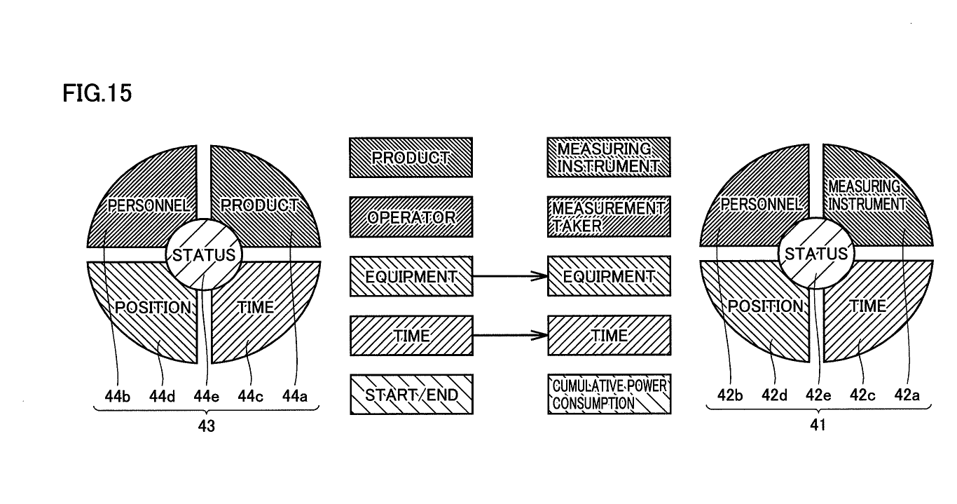

Yet another embodiment of the present disclosure will be described. First, a description will be made about event data used in the trace information acquisition system according to the embodiment of the present disclosure. FIG. 15 is a conceptual diagram representing the data format of event data. Referring to FIG. 15, an event data set 41 describes a power consumption monitoring event performed to monitor how much electric power has been consumed as energy in production processes of a product that is manufactured through a plurality of stages. The event data set 41 is stored in a common data format at every product manufacturing stage. The event data set 41 contains measuring instrument data 42a which is information about a measuring instrument related to the power consumption monitoring event for a product to be sensed, personnel data 42b which is information about a person involved in the power consumption monitoring event, time data 42c which is time information related to the power consumption monitoring event, positional data 42d which is location information related to the power consumption monitoring event, and status data 42e which is status information related to the power consumption monitoring event. The measuring instrument data 42a, personnel data 42b, time data 42c and positional data 42d are conceptually linked with one another via the status data 42e.

The event data set regarding the power consumed for a product in a production process, in other words, the event data about the power consumption monitoring event for monitoring the power consumed for a product in a production process can be associated with the event data set about the production process of the product. Specifically, product (object) data 44a regarding a product to be sensed, personnel data 44b regarding a person, time data 44c regarding time, positional data 44d regarding a position (location), and status data 44e regarding a status included in a product production process event data set 43 are configured to associate with the measuring instrument data 42a, personnel data 42b, time data 42c, positional data 42d and status data 42e in the event data set 41. More specifically, with agreement between the personnel data 44b describing an operator and the personnel data 42b describing a data recorder, between the positional data 44d describing equipment and the positional data 42d describing equipment, and between the time data 44c describing time and the time data 42c describing time, the product data 44a in a production process of a product and the measuring instrument data 42a in the production process of the product can be associated with each other. Using the associated event data sets specifying the same person, the same location and the same time in the production processes of the product, trace information regarding the power consumption in the production processes of the product.

Referring back to the aforementioned FIG. 2, a hardware system configuration of the trace information acquisition system according to the embodiment of the present disclosure will be described. Referring to FIG. 15, the trace information acquisition system 21 includes a server 22 capable of storing various types of data, such as the event data and an event data master storing a plurality of event data sets, a server 23 constructing an existing system and storing production-management related data, a process master and BOM (Build Of Material) master, computers 24a, 24b, 24c, 24d used to input data including the event data, a sensing device 25a enabling direct input of the event data, a sensing device 25b enabling input of the event data via the computer 24c, and a connecting line 26 connecting the servers 22, 23 and computers 24a to 24d. The server 22 includes storage unit to store event data regarding power consumed in production processes of a product and acquisition unit to acquire trace information regarding the power consumed in the production processes of the product from the event data stored by the storage unit. The computer 24c functions as a device setting interface for the sensing device 25b. The trace information acquisition system 21 also includes an RFID tag system 27 capable of inputting and outputting event data of a remotely placed product. The RFID tag system 27 includes a reader/writer 28a provided to the computer 24d and an RFID tag 28b that is attached on a product 29 and is readable and writable, in other words, containing data in which the reader/writer 28a can input and output. The computer 24d functions as an external storage data interface for the RFID tag system 27.

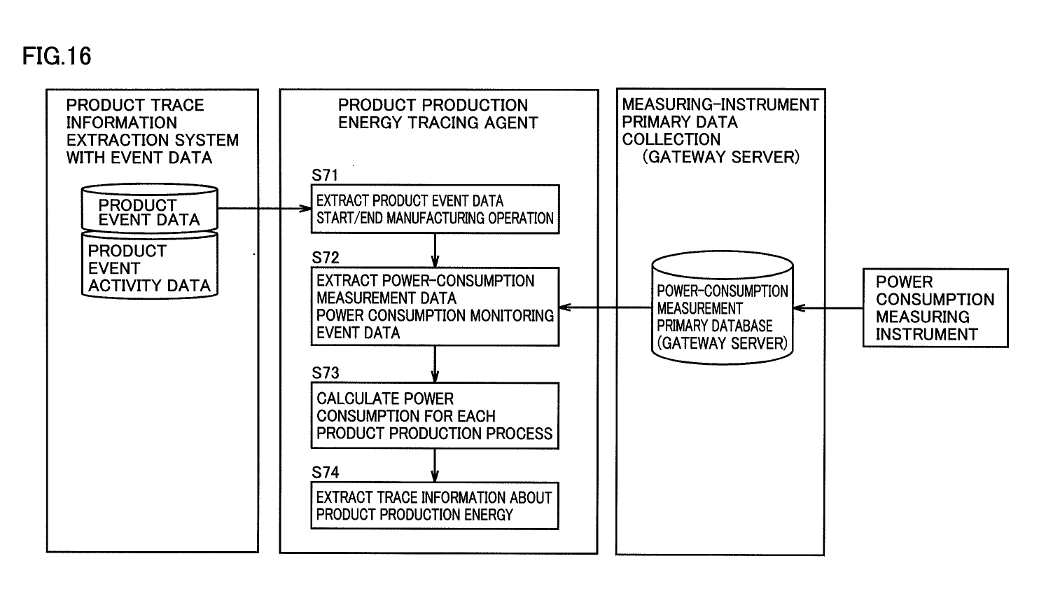

Referring back to FIG. 3, a description will be now made about a method for storing event data regarding power consumption in production processes of a product. FIG. 16 is a block diagram of the trace information acquisition system according to the embodiment of the present disclosure. The first method described with FIG. 16 and some other drawings is a method for storing event-sensing type event data by devices. The method is to directly acquire event data from sensing devices, such as the sensing devices 25a and 25b in the system configuration view of FIG. 2, and to store the event data.

At first, data is captured from the sensing device (device) 25b through the device setting interface of the computer 24c (step S11 in FIG. 3, the “step” is hereinafter omitted). Secondly, event data with the above-described structure is created by the interface logic of the computer 24c (S12). Thirdly, databases of the event data master stored in the server 22 are updated (S14). The event data master updated in this embodiment includes a table master, status master, positional master, measuring instrument master and personnel master. The database updates are equivalent to storing new event data into respective masters.

The event data master herein is used to associate the data of the event data with the contents of the event data. For example, personnel data is stored in the form of simple symbols, such as numerals and letters of alphabet. The personnel master in the event data master stores the association between the symbol and information, such as the name of an actual operator and the department the operator belongs to. The status master, positional master and measuring instrument master are also structured in the same manner. The table master is available for various databases. Note that the time data is represented simply by year, month, day and time and does not need to associate with other information, and therefore there is no master for time data.

The same method for storing data-transfer type event data with an existing system is adopted in this embodiment, and therefore the descriptions thereof will not be reiterated.

A method for acquiring trace information regarding power consumption in production processes of a product by using event data will be described. FIG. 16 is a flow chart showing an operation flow to acquire the trace information regarding power consumed in production processes of a product. Referring now to FIG. 16 and some other drawings, information, serving as a tracing agent, of a target product whose trace information is intended to be acquired is input into the server 22 (S71). Alternatively, product event data may be extracted and input into the server 22. Then, event data sets regarding power consumption in production processes of a product manufactured through a plurality of stages are extracted (S72). Specifically, as shown in FIG. 3, event data sets related to power-consumption monitoring events for monitoring the power consumed in the production processes of the product are extracted from a gateway server that stores a power-consumption measurement primary database constructed based on data from the power-consumption measuring instrument. The acquisition unit in the server 22 includes extraction unit to extract a plurality of event data sets related to one another from a plurality of event data sets stored by the storage unit. Subsequently, based on personnel data, time data and positional (location) data in the event data sets, simultaneously occurring events involving one and the same person, that is, power consumption monitoring events with the same personnel data, the same time data and the same positional data are extracted. In the extraction, the extraction unit extracts, from the plurality of event data sets, event data sets having the same positional data as associated event data sets.

Based on the extracted power consumption monitoring event data sets, the consumed power is calculated (S73). The consumed power can be obtained by, for example, subtracting the measuring instrument data in an event data with later time data from the measuring instrument data in an event data with earlier time data.

In the aforementioned manner, trace information about energy in production processes of a product, or trace information regarding electric power consumption in this description, is acquired from the event data sets (S74).

According to the trace information acquisition system, the event data sets about power consumption in production processes of a product are stored in a common data format at a plurality of stages, thereby enabling acquisition of trace information regarding the power consumption in the production processes of the product based on the stored event data sets. This allows the acquisition of trace information regarding the power consumption in the production processes of the product manufactured through the plurality of stages irrespective of infrastructures. For example, the acquisition of the trace information regarding the power consumption in the production processes of the product manufactured through the plurality of stages can take place without storing data required to associate the stages with one another. Even if, therefore, the product is manufactured in fields not sharing an infrastructure, trace information regarding power consumption in the production processes of the product can be acquired.

The method for acquiring trace information according to the disclosure is to acquire trace information regarding a product manufactured through a plurality of stages and includes a step of storing event data sets about energy in production processes of a product, the event data sets stored at the plurality of stages having a common data format, and a step of acquiring trace information about energy in the production processes of the product from the event data stored in the storing step.

A trace information acquisition apparatus according to the disclosure is to acquire trace information regarding a product manufactured through a plurality of stages and includes a storage section storing event data sets regarding energy in production processes of a product, the event data sets stored at the plurality of stages having a common data format, and an acquisition section acquiring trace information about energy in the production processes of the product from the event data sets stored by the storage section. The trace information acquisition apparatus corresponds to the server 22 in FIG. 2.

A trace information acquisition program according to the disclosure causes a computer, in order to acquire trace information regarding a product manufacture through a plurality of stages, to function as storage unit storing event data sets regarding energy in production processes of a product, the event data sets stored at the plurality of stages having a common data format, and acquisition unit acquiring trace information regarding energy in the production processes of the product from the event data sets stored by the storage unit.

A recording medium according to the disclosure is a computer-readable recording medium storing the trace information acquisition program.

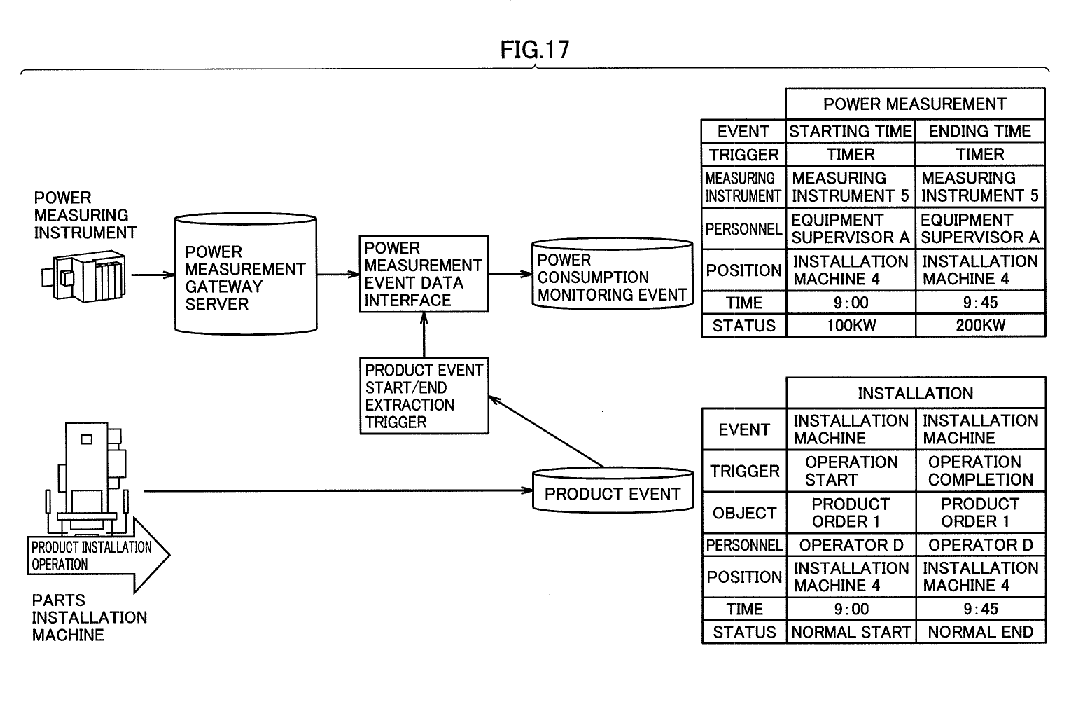

A description will be made about yet another embodiment of the trace information acquisition system according to the present disclosure. FIG. 17 illustrates an example of event data obtained during operations for assembling a product. Referring to FIG. 17, the operations for measuring electric power with a power measuring instrument includes power measurement that involves: a “starting time” event whose trigger specifies “timer”; and an “ending time” event whose trigger specifies “timer”. For these events, event data sets as shown in FIG. 17 are stored.

Specifically, the “starting time” event with the trigger specifying “timer” stores measuring instrument data of “measuring instrument 5”, personnel data of “equipment supervisor A”, positional data of “installation machine 4”, time data of “9:00”, and status data of “100 KW” as an event data set. This means that the equipment supervisor A started operations with the installation machine 4 in which the measuring instrument 5 indicates 100 KW at 9:00. Similarly, the “ending time” event with the trigger specifying “timer” stores measuring instrument data of “measuring instrument 5”, personnel data of “equipment supervisor A”, positional data of “installation machine 4”, time data of “9:45”, and status data of “200 KW” as an event data set. This means that the equipment supervisor A finished the operations with the installation machine 4 in which the measuring instrument 5 indicates 200 KW at 9:45.

In addition, the operations for installing the product involve an “installation machine” event whose trigger specifies “start operations” and an “installation machine” event whose trigger specifies “finish operations”. As shown in FIG. 17, the “installation machine” event with the trigger specifying “start operations” stores object data of “product order 1”, personnel data of “operator D”, positional data of “installation machine 4”, time data of “9:00”, and status data of “normal start” as an event data set. This means that OPERATOR D properly issued PRODUCT ORDER 1 to INSTALLATION MACHINE 4 at 9:00. Similarly, the “INSTALLATION MACHINE” event with the trigger specifying “FINISH OPERATIONS” stores object data of “PRODUCT ORDER 1”, personnel data of “OPERATOR D”, positional data of “INSTALLATION MACHINE 4”, time data of “9:45”, and status data of “normal termination” as an event data set. This means that OPERATOR D properly finished issuing PRODUCT ORDER 1 with INSTALLATION MACHINE 4 at 9:45.

After the acquisition of the pieces of trace information, the trace information pieces related to power consumption in production processes of a product are associated with one another as shown by solid arrows in FIG. 17. Specifically, all of the positional data in the event data sets related to the installation machine 4 hold “installation machine 4”. As shown in FIG. 17, trace information pieces regarding power consumption in the production processes of the product can be associated with one another from the event data sets without directly storing the associations between the “starting time” event and “ending time” event. In this case, the acquired trace information indicates 100 KW, which is obtained by subtracting 100 KW from 200 KW, as the electric power that has been consumed from the start to the end of the production process.

The additional associations can be created using the event data sets of the production process of the product. Specifically, the event data sets involved in the power measurement are associated with the event data sets involved in the installation via “installation machine 4” of the positional data in FIG. 17, and the associated event data sets can be used to derive trace information.

The trace information acquisition system can acquire trace information regarding energy in the production processes of the product manufactured through a plurality of stages irrespective of infrastructures. For example, the acquisition of the trace information regarding energy in the production processes of the product manufactured through the plurality of stages can take place without storing data required to associate the stages with one another. Even if, therefore, the product is manufactured in fields not sharing an infrastructure, trace information regarding energy in the production processes of the product can be acquired.

The method for acquiring trace information, the trace information acquisition apparatus, and the trace information acquisition program and recording medium can also acquire trace information regarding energy in production processes of a product manufactured through a plurality of stages irrespective of infrastructures. For example, the acquisition of the trace information regarding energy in the production processes of the product manufactured through the plurality of stages can take place without storing data required to associate the stages with one another. Even if, therefore, the product is manufactured in fields not sharing an infrastructure, trace information regarding energy in the production processes of the product can be acquired.

The above-described embodiment deals with electric power as energy; however, the present disclosure is not limited thereto and can be applied to cases using gas, thermal power, hydropower and so on.

The trace information is acquired from the event data and event activity data in the embodiments; however, the present disclosure is not limited thereto and can be configured to store only event data and acquire trace information from the stored event data.

The foregoing has described the embodiment of the present disclosure by referring to the drawings. However, the invention should not be limited to the illustrated embodiment. It should be appreciated that various modifications and changes can be made to the illustrated embodiment within the scope of the appended claims and their equivalents.

The trace information acquisition system, the method for acquiring trace information, the trace information acquisition apparatus, and the trace information acquisition program and recording medium according to the disclosure are effectively used to properly acquire trace information in environments not sharing an infrastructure.

What is claimed is:

1. A trace information acquisition system configured to acquire trace information regarding a product manufactured through a plurality of stages comprising:
a storage configured to store event data sets regarding events performed on the product; and
an acquirer configured to acquire trace information from the event data sets stored by the storage, wherein
the event data sets stored at the plurality of stages have a common data format.

2. The trace information acquisition system according to claim 1, wherein
each of the event data sets includes object data related to an event, personnel data related to the event, time data related to the event, positional data related to the event and status data related to the event.

3. The trace information acquisition system according to claim 1, wherein
the storage stores event activity data sets comprising business activity information required to be stored upon event occurrence, and
the acquirer acquires trace information from the event activity data sets stored by the storage.

4. The trace information acquisition system according to claim 1, wherein
the acquirer includes an extractor that extracts a plurality of event data sets associated with one another from a plurality of the event data sets stored by the storage.

5. The trace information acquisition system according to claim 4, wherein
the associated event data sets extracted from the plurality of the event data sets by the extractor are event data sets with the same time data related to the events.

6. The trace information acquisition system according to claim 1, wherein
the storage stores the event data sets using a radio frequency identification (RFID) tag.

7. The trace information acquisition system, according to claim 1, wherein
the storage stores event data sets regarding the quality of in-process product in production processes, and
the acquirer acquires trace information regarding the quality of the in-process product in the production processes from the event data sets stored by the storage.

8. The trace information acquisition system according to claim 7, wherein
each of the event data sets includes storage identification (ID) data related to a storage event for storing quality information of the in-process product in the production processes, personnel data related to the storage event for storing the quality information, time data related to the storage event for storing the quality information, positional data related to the storage event for storing the quality information, and status data related to the storage event for storing the quality information.

9. The trace information acquisition system according to claim 7, wherein
the storage stores event activity data sets that are business activity information required to be stored upon occurrence of the event for storing the quality information, and
the acquirer acquires trace information regarding the quality of the in-process product in the production processes from the event activity data sets stored by the storage.

10. The trace information acquisition system according to claim 4, wherein
the associated event data sets extracted from the plurality of the event data sets by the extractor are event data sets with the same positional data.

11. The trace information acquisition system, according to claim 1, wherein
the storage stores event data sets regarding energy in production processes of a product, and
the acquirer acquires trace information regarding energy in the production processes of the product from the event data sets stored by the storage.

12. The trace information acquisition system according to claim 11, wherein
each of the event data sets includes measuring instrument data that comprising information about a measuring instrument used to measure energy, personnel data related to a person who measures the energy, time data related to time for measuring the energy, positional data related to a location where the energy is measured, and status data related to a status in energy measurement operations.

13. A method for acquiring trace information regarding a product manufactured through a plurality of stages, the method comprising the steps of:
storing event data sets regarding events performed on the product, the event data sets stored at the plurality of stages having a common data format; and
acquiring trace information from the event data sets stored in the storing step.

14. The method for acquiring trace information regarding a product manufactured through a plurality of stages according to claim 13, wherein
the storing includes storing event data sets regarding the quality of in-process product in production processes, the event data sets stored at the plurality of stages having a common data format, and
the acquiring includes acquiring trace information regarding the quality of the in-process product in the production processes from the event data sets stored in the storing step.

15. The method for acquiring trace information regarding a product manufactured through a plurality of stages according to claim 13, wherein
the storing includes storing event data sets regarding energy in production processes of a product, the event data sets stored at the plurality of stages having a common data format, and
the acquiring includes acquiring trace information regarding energy in the production processes of the product from the event data sets stored in the storing step.

16. A trace information acquisition apparatus for acquiring trace information regarding a product manufactured through a plurality of stages comprising:
a storage that stores event data sets regarding events performed on the product, the event data sets stored at the plurality of stages having a common data format; and
an acquirer that acquires trace information from the event data sets stored by the storage.

17. The trace information acquisition apparatus for acquiring trace information regarding a product manufactured through a plurality of stages according to claim 16, wherein
the storage stores event data sets regarding the quality of in-process product in production processes, the event data sets stored at the plurality of stages having a common data format, and
the acquirer acquires trace information regarding the quality of the in-process product in the production processes from the event data sets stored by the storage section.

18. The trace information acquisition apparatus for acquiring trace information regarding a product manufactured through a plurality of stages according to claim 16, wherein
the storage stores event data sets regarding energy in production processes of a product, the event data sets stored at the plurality of stages having a common data format, and
the acquirer acquires trace information regarding energy in the production processes of the product from the event data sets stored by the storage section.

19. A non-transitory computer readable medium storing a computer program that acquires trace information regarding a product manufactured through a plurality of stages, the program causing the computer to execute:
storing event data sets regarding events performed on the product, the event data sets stored at the plurality of stages having a common data format, and
acquiring trace information from the event data sets stored by the storage.

20. The non-transitory computer readable medium according to claim 19, further causing the computer to execute:
storing event data sets regarding the quality of in-process product in production processes, the event data sets stored at the plurality of stages having a common data format, and
acquiring trace information regarding the quality of the in-process product in the production processes from the event data sets stored by the storage.

21. The non-transitory computer readable medium according to claim 19, further causing the computer to execute:
storing event data sets regarding energy in production processes of a product, the event data sets stored at the plurality of stages having a common data format, and
acquiring trace information regarding energy in the production processes of the product from the event data sets stored by the storage.
